(19) United States
(12) Patent Application Publication
(10) Pub. No.: US 2026/0063892 A1
(43) Pub. Date: Mar. 5, 2026

(54) CONTINUOUSLY ADJUSTABLE RESONANCE FREQUENCY SCANNING 1D MIRROR

(71) Applicant: Orbotech Ltd., Yavne (IL)

(72) Inventors: Tal Goichman, Kiryat Ono (IL); Arkady Bronfman, Yavne (IL); Ashkan Aghajani, Yavne (IL); Mordechai Hai Hababo, Yavne (IL)

(21) Appl. No.: 18/897,615

(22) Filed: Sep. 26, 2024

Related U.S. Application Data
(60) Provisional application No. 63/687,850, filed on Aug. 28, 2024.

(51) Int. Cl. G02B 26/08; G02B 26/10

(52) U.S. Cl. CPC G02B 26/0816; G02B 26/10

(57) ABSTRACT

The system includes a support member configured to support a mirror, a fulcrum configured to centrally support the support member, and a base configured to support the fulcrum. A voice coil is disposed on the base member on one side of the fulcrum and connected to one end of the support member. A processor is configured to send an excitation signal to the voice coil, which causes the support member to oscillate relative to the fulcrum.

### CROSS-REFERENCE TO RELATED APPLICATIONS

This application claims priority to U.S. Provisional Application No. 63/687,850, filed Aug. 28, 2024, the entire disclosure of which is hereby incorporated by reference herein.

### FIELD OF THE DISCLOSURE

This disclosure relates to inspection systems and, more particularly, to inspection systems for detecting defects in semiconductor substrates.

### BACKGROUND OF THE DISCLOSURE

Evolution of the electronics manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for an electronics manufacturer.

Inspection processes are used at various steps during electronics manufacturing to detect defects on wafers, electronic devices, or electrical circuits to promote higher yield in the manufacturing process and, thus, higher profits. Inspection has always been an important part of fabricating electronic devices such as integrated circuits (ICs), flat panel displays (e.g., organic light emitting diode on silicon (OLEDoS) display panels), and printed circuit boards (PCBs), including assembled PCBs. However, as feature dimensions decrease, inspection becomes even more important to the successful manufacture of acceptable electronic devices because smaller defects can cause devices and assemblies to fail. For instance, as feature dimensions decrease, detection of defects of decreasing size has become necessary because even relatively small defects may cause unwanted aberrations in the devices.

In various inspection processes, a mirror can be used to reflect light from a workpiece onto a detector for imaging. When light is scanned across the workpiece (e.g., by moving a stage holding the workpiece), image quality can be improved by rotating the mirror along with the scanning movement. A common mirror assembly configured for one-dimensional scanning is a galvo mirror, in which a mirror is attached via a shaft to a galvo actuator to rotate the mirror, while an encoder monitors an angle between shaft and housing. While this method can produce various motion profiles with a large angular range (e.g., greater than 10 degrees), the size of the mirror is limited (e.g., up to 1 inch wide). This is because as the mirror size grows, its inertia grows exponentially, and dynamic performance (speed, acceleration, stability) drops significantly. Thus, direct drive using a galvo mirror provides limitations on inspection performance due to the small mirror size.

Another type of mirror assembly is a resonant mirror, which operates at a specific fast frequency based on the spring/mass ratio of the mirror assembly and can obtain high local angular velocities. However, this method can only perform at a sinusoidal motion profile at the specific frequency, and working outside this frequency is impossible due to lack of gain. Thus, these mirror assemblies are not adaptable to different inspection parameters and scan speeds.

Another type of mirror assembly is a piezo-based fast steering mirror, which has the same limitations as a galvo mirror when the mirror size gets as large 2 inches. These fast-steering mirrors movement rely on a long stack of piezo elements to produce large angular range of motion, but the length of the stack compromises motion dynamics. Thus, these mirror assemblies require a compromise between fast motion over a very small range, or slower speed for larger travel range, which limits their usefulness in inspection processes.

Therefore, what is needed is an improved mirror assembly that is configured for high-speed and adjustable rotation of large mirrors.

### BRIEF SUMMARY OF THE DISCLOSURE

An embodiment of the present disclosure provides a system. The system may comprise a support member configured to support a mirror, a fulcrum configured to centrally support the support member, a base member configured to support the fulcrum, a voice coil disposed on the base member on one side of the fulcrum and connected to one end of the support member, and a processor configured to send an excitation signal to the voice coil, which causes the support member to oscillate relative to the fulcrum.

In some embodiments, the system may further comprise a pair of flexible extension members spanning from each end of the support member to the base member. An effective length of the pair of flexible extension members may limits an angular range of oscillation of the support member.

In some embodiments, the system may further comprise a pair of stiffness supports disposed on the base member beneath the pair of flexible extension members and configured to move laterally relative to the pair of flexible extension members to adjust the effective length of the pair of extension members and the angular range of oscillation of the support member.

In some embodiments, the processor may be configured to send instructions to an actuator to move each of the pair of stiffness supports to adjust the effective length of the pair of extension members and the angular range of oscillation of the support member.

In some embodiments, the system may further comprise a pair of masses disposed on the support member and configured to move laterally along the support member to adjust the angular inertia of the support member and the angular range of oscillation of the support member.

In some embodiments, the processor may be configured to send instructions to an actuator to move the pair of masses to adjust the angular inertia of the support member and the angular range of oscillation of the support member.

In some embodiments, the system may further comprise a feedback sensor disposed on the support member and configured to measure an oscillation frequency of the support member.

In some embodiments, the system may further comprise a light source configured to emit light onto a workpiece and a camera configured to capture an image of the workpiece based on the light reflected by the workpiece. The mirror may be configured to direct the light reflected by the workpiece toward the camera.

In some embodiments, the system may further comprise a stage configured to support the workpiece. The stage may be movable to scan the light emitted by the light source across the workpiece. The camera may be configured to capture a plurality of images of the workpiece as the stage scans the light emitted by the light source across the workpiece.

In some embodiments, the stage may be movable at a linear velocity, and the support member may be configured to oscillate at an angular velocity synchronized with the linear velocity.

In some embodiments, the system may further comprise a memory configured to store a lookup table including pairs of linear velocities of the stage and angular velocities of the support member. The processor may be configured to obtain a target angular velocity of the support member based on the linear velocity of the stage and adjust the effective length of the pair of extension members such that the support member oscillates at the target angular velocity.

Another embodiment of the present disclosure provides a method. The method may comprise: emitting light from a light source onto a workpiece; moving a stage supporting the workpiece to scan the light emitted by the light source across the workpiece, wherein the stage is moved at a linear velocity; applying an excitation signal to a voice coil disposed on a base member of a mirror assembly on one side of a fulcrum, wherein the fulcrum centrally supports a support member supporting a mirror, and the excitation signal causes the voice coil to oscillate the support member relative to the fulcrum at an angular velocity synchronized with the linear velocity of the stage; and capturing at least one image of the workpiece with a camera based on the light reflected by the workpiece, wherein the mirror is configured to direct the light reflected by the workpiece toward the camera.

In some embodiments, the method may further comprise: determining a target angular velocity of the support member based on a synchronized correspondence with the linear velocity of the stage; determining an adjustment value of the mirror assembly, such that the angular range of oscillation of the support member corresponds to the target angular velocity; and adjusting the mirror assembly based on the adjustment value, such that the support member is configured to oscillate at an angular velocity that is synchronized with the linear velocity of the stage.

In some embodiments, the method may further comprise measuring, with a feedback sensor, an oscillation frequency of the support member; and determining whether the oscillation frequency corresponds to the target angular velocity.

In some embodiments, the method may further comprise: in response to determining that the oscillation frequency does not correspond to the target angular velocity, determining a correction value of the mirror assembly, such that the angular range of oscillation of the support member corresponds to the target angular velocity; and adjusting the mirror assembly based on the correction value, such that the support member is configured to oscillate at an angular velocity that is synchronized with the linear velocity of the stage.

In some embodiments, a pair of flexible extension members may span from each end of the support member to the base member, and a pair of stiffness supports may be disposed on the base member beneath the pair of flexible extension members, and adjusting the mirror assembly based on the adjustment value may comprise moving the pair of stiffness supports according to the adjustment value.

In some embodiments, adjusting the mirror assembly based on the correction value may comprises moving the pair of stiffness supports according to the correction value.

In some embodiments, a pair of masses may be disposed on the support member, and adjusting the mirror assembly based on the adjustment value may comprise moving the pair of masses according to the adjustment value.

In some embodiments, adjusting the mirror assembly based on the correction value may comprise moving the pair of masses according to the correction value.

In some embodiments, the method may further comprise in response to determining that the oscillation frequency does not correspond to the target angular velocity, determining an adjusted excitation signal for the voice coil; and applying the adjusted excitation signal to the voice coil, such that the voice coil oscillates the support member at the angular velocity synchronized with the linear velocity of the stage.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram of a system according to an embodiment of the present disclosure;

FIG. 2 is a diagram of a mirror assembly according to an embodiment of the present disclosure;

FIG. 3A and FIG. 3B are diagrams showing the angular range of motion of the mirror assembly of FIG. 2;

FIG. 4A is a diagram of a mirror assembly according to another embodiment of the present disclosure;

FIG. 4B is a diagram of the mirror assembly of FIG. 4A shown in a different configuration;

FIG. 5A is a diagram of a mirror assembly according to another embodiment of the present disclosure;

FIG. 5B is a diagram of the mirror assembly of FIG. 5A shown in a different configuration;

FIG. 6 is a flowchart of a method according to an embodiment of the present disclosure;

FIG. 7 is a flowchart of a method according to another embodiment of the present disclosure; and

FIG. 8 is a flowchart of a method according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

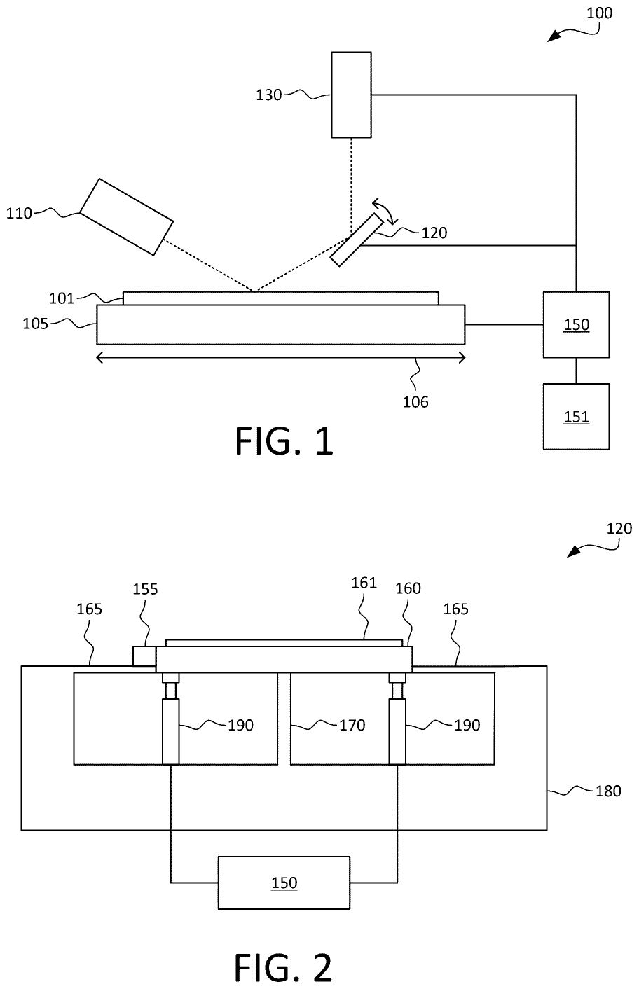

An embodiment of the present disclosure provides a system 100, as shown in FIG. 1. The system 100 may be an inspection system configured to inspect a workpiece 101 to detect defects in the workpiece 101. The workpiece 101 may be a semiconductor wafer, substrate, printed circuit board (PCB), flat panel display (FPD), or other type of workpiece and is not limited herein.

The system 100 may comprise a light source 110. The light source 110 may be configured to emit light 111. The light source 110 may be configured to emit the light 111 in continuous or pulsed modes. The light 111 may be configured to illuminate the workpiece 101. The light 111 may illuminate the workpiece 101 for several microseconds up to hundreds of microseconds or more. The light 111 may be infrared light, visible light, or ultraviolet light.

The system 100 may further comprise a stage 105. The stage 105 may be configured to support the workpiece 101. The stage 105 may be movable to scan the light 111 across the workpiece 101. For example, the stage 105 may be configured to move with a linear velocity of 100 mm/s to 1000 mm/s.

The system 100 may further comprise a mirror assembly 120 configured to direct reflected light 112 from the workpiece 101 to a camera 130. The camera 130 may be configured to receive the reflected light 112 and generate one or more images of the workpiece 101 based on the reflected light 112 received by the camera 130. For example, the camera 130 may be specifically configured to generate one or more images of the workpiece 101 based on the type of the light 111 emitted by the light source 110 (e.g., infrared light, visible light, or ultraviolet light).

The system 100 may further comprise a processor 150. The processor 150 may include a microprocessor, a microcontroller, or other devices. The processor 150 may be coupled to the components of the system 100 in any suitable manner (e.g., via one or more transmission media, which may include wired and/or wireless transmission media) such that the processor 150 can receive output. The processor 150 may be configured to perform a number of functions using the output. An inspection tool can receive instructions or other information from the processor 150. The processor 150 optionally may be in electronic communication with another inspection tool, a metrology tool, a repair tool, or a review tool (not illustrated) to receive additional information or send instructions.

The processor 150 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 150 may be disposed in or otherwise part of the system 100 or another device. In an example, the processor 150 may be part of a standalone control unit or in a centralized quality control unit. Multiple processors 150 may be used, defining multiple subsystems of the system 100.

The processor 150 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 150 to implement various methods and functions may be stored in readable storage media, such as a memory.

If the system 100 includes more than one subsystem, then the different processors 150 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 150 may be configured to perform a number of functions using the output of the system 100 or other output. For instance, the processor 150 may be configured to send the output to an electronic data storage unit or another storage medium. The processor 150 may be further configured as described herein.

The processor 150 may be configured according to any of the embodiments described herein. The processor 150 also may be configured to perform other functions or additional steps using the output of the system 100 or using images or data from other sources.

The processor 150 may be communicatively coupled to any of the various components or sub-systems of system 100 in any manner known in the art. Moreover, the processor 150 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 150 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 150 (or computer subsystem) or, alternatively, multiple processors 150 (or multiple computer subsystems). Moreover, different sub-systems of the system 100 may include one or more computing or logic systems. Therefore, the above description should not be interpreted as a limitation on the present disclosure but merely an illustration.

The processor 150 may be in electronic communication with the stage 105. For example, the processor 150 may be configured to send instructions to one or more motors or actuators of the stage 105 to move the stage 105 along the first axis 106 at a constant linear velocity. For example, the one or more actuators of the stage 105 may be configured to move the stage 105 various linear velocities, and the instructions sent to the one or more actuators of the stage 105 may include a target linear velocity of the various preset linear velocities for movement of the stage 105 along the first axis 106.

The processor 150 may be in electronic communication with the light source 110 and the camera 130. For example, the processor 150 may be configured to send instructions to the light source 110 to emit the light 111 to illuminate the workpiece 101 and send instructions to the camera 130 to capture one or more images of the workpiece 101 based on the reflected light 112 received by the camera 130.

The processor 150 may be in electronic communication with the mirror assembly 120. For example, the processor 150 may be configured to send instructions to the mirror assembly 120 to control movement of the mirror assembly 120 in a manner that is synchronized with the movement of the stage 105. Specifically, the mirror assembly 120 may be configured to cause a mirror to oscillate at its natural or resonant frequency, in which the angular velocity of the mirror has a period of near-linear velocity. When the linear velocity of the stage 105 is synchronized with the period of near-linear velocity of the mirror assembly 120,, the camera 130 can “see” a frozen image and can receive a large quantity of reflected light 112, which can improve resolution of captured images. As further described below, the movement of the mirror assembly 120 may depend on the variable structure of the elements of the mirror assembly 120, so as to adapt to different linear velocities of the stage 105.

As shown in FIG. 2, the mirror assembly 120 may comprise a support member 160 configured to support a mirror 161. In some embodiments, the mirror 161 may be a rectangular or circular mirror, having a largest dimension of, for example, 2 inches or more. The mirror 161 may be made of a light, reflective material, such as, for example, SiC or Be, and can be bonded to the support member 160. The mirror assembly 120 may further comprise a fulcrum 170 configured to support the support member 160, and a base member 180 configured to support the fulcrum 170. In some embodiments, the support member 160, the fulcrum 170, and the base member 180 may be integrally formed. For example, the support member 160, the fulcrum 170, and the base member 180 may be a monolithic component produced by electric discharge machining (EDM) or other additive/subtractive manufacturing processes or an elastic metal such as, for example, BeCu or spring steel. The support member 160 may be configured to rotate relative to the base member 180 via bending of the fulcrum 170. The flexible nature of the elements of the mirror assembly 120 can allow for highly repeatable oscillating movement, with minimal degradation over time.

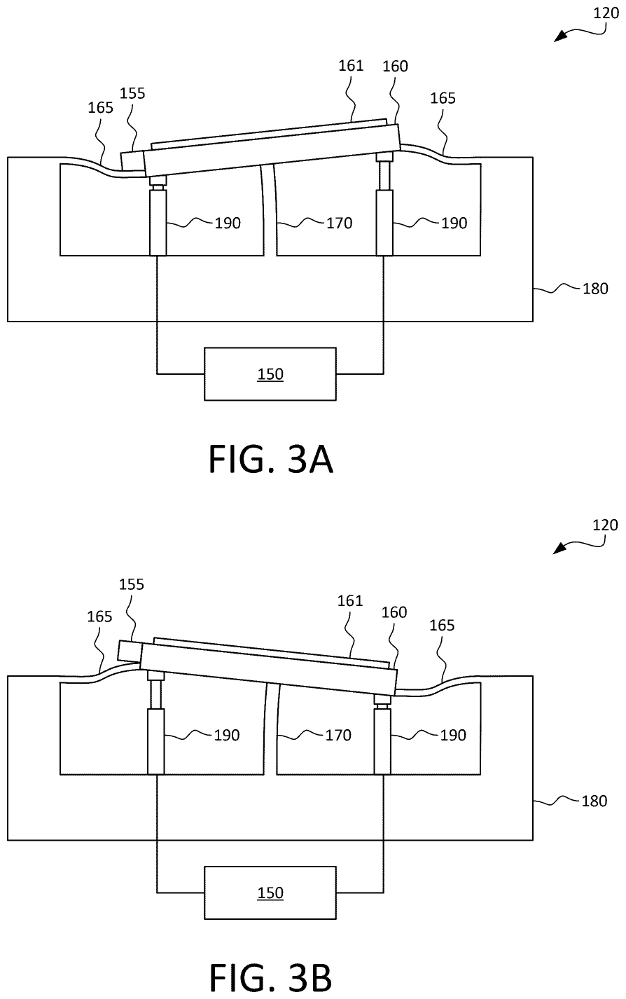

The mirror assembly 120 may further comprise a voice coil 190 disposed on the base member 180 on one side of the fulcrum 170 and connected to one end of the support member 160. In some embodiments, a pair of voice coils 190 may be disposed on the base member 180 on opposite sides of the fulcrum and connected to opposite ends of the support member 160. Each voice coil 190 may be configured to push and/or pull the respective ends of the support member 160 to cause the support member 160 to rotate relative to the base member 180 via bending of the fulcrum 170. The processor 150 may be in electronic communication with each voice coil 190. For example, the processor 150 may be configured to send an excitation signal to the coil 190, which may cause the support member 160 to oscillate relative to the fulcrum 170. The excitation signal may induce opposite push/pull forces from the pair of voice coils 190 (or single voice coil 190) such that the support member 160 oscillates at its natural frequency, with a defined angular velocity. For example, the mirror assembly 120 may be configured to oscillate between the positions shown in FIG. 3A and FIG. 3B in accordance with the push/pull forces of the pair of voice coils 190. At the natural frequency, the force and current of the voice coil 190 may be minimal, regardless of dimensions or weight of the mirror 161. The use of one voice coil 190 or a pair of voice coils 190 may depend on the force needed to rotate the support member 160. With the angular velocity of the support member 160 synchronized with the linear velocity of the stage 105 (i.e., the near-linear velocity of the support member 160 is synchronized with the linear velocity of the stage 105), the mirror 161 can direct the reflected light 112 toward the camera 130, to improve image resolution.

In some embodiments, the mirror assembly 120 may further comprise a pair of flexible extension members 165. The pair of flexible extension members 165 may span from each end of the support member 160 to the base member 180. In some embodiments, the pair of flexible extension members 165 may be integrally formed with the support member 160, the fulcrum 170, and the base member 180 of the mirror assembly 120. When the support member 160 rotates relative to the base member 180 via bending of the fulcrum 170, the pair of flexible extension members 165 may also bend, and the angular range of oscillation of the support member 160 may be limited by an effective length of the pair of flexible extension members 165. Accordingly, the effective length of the pair of flexible extension members 165 may further affect the natural frequency of the support member 160 and its angular velocity of rotation.

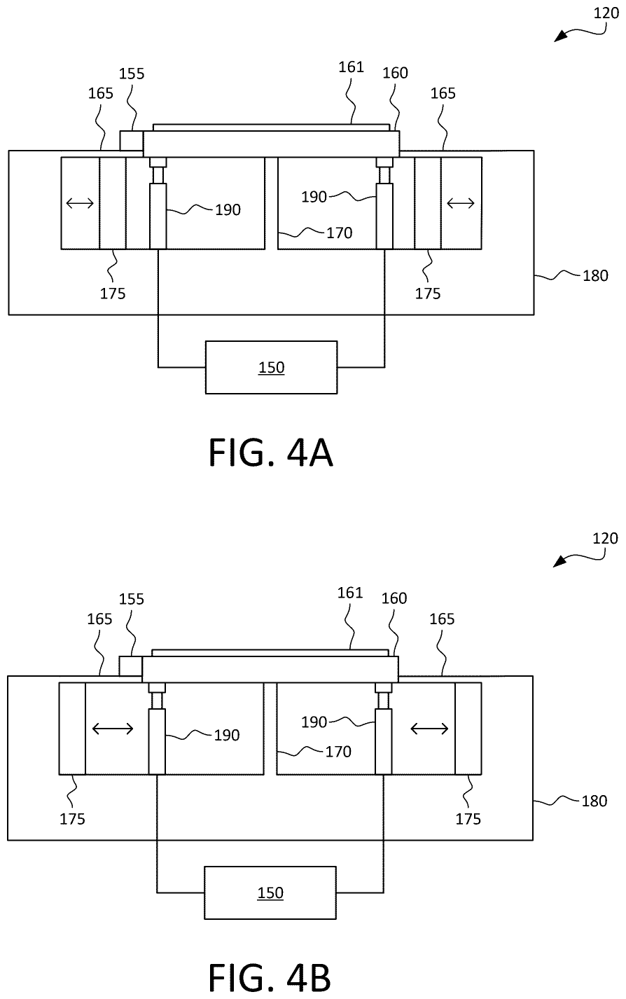

In some embodiments, the mirror assembly 120 may further comprise a pair of stiffness supports 175 disposed on the base member 180 beneath the pair of flexible extension members 165, as shown in FIG. 4A and FIG. 4B. The pair of stiffness supports 175 may be configured to move laterally relative to the pair of flexible extension members 165 to adjust the effective length of the pair of extension members 165 and the angular range of oscillation of the support member. For example, by moving the pair of stiffness supports 175 inward toward the fulcrum 170 (as shown in FIG. 4A), the angular range of oscillation of the support member 160 may decrease, while moving the pair of stiffness supports 175 outward from the fulcrum 170 (as shown in FIG. 4B), the angular range of oscillation of the support member 160 may increase. It should be understood that the positions of the pair of stiffness supports 175 shown in FIG. 4A and FIG. 4B are exemplary, and the pair of stiffness supports 175 can be moved to other positions between and/or beyond the illustrated examples. The processor 150 may be configured to send instructions to one or more actuators to move each of the pair of stiffness supports 175 to adjust the effective length of the pair of extension members 165, and thereby adjust the angular range of oscillation of the support member 160. Consequently, the natural frequency of the mirror assembly 120 can be adjusted by adjusting the position of the pair of stiffness supports 175, which can allow for synchronization of the angular velocity with different linear velocities of the stage 105.

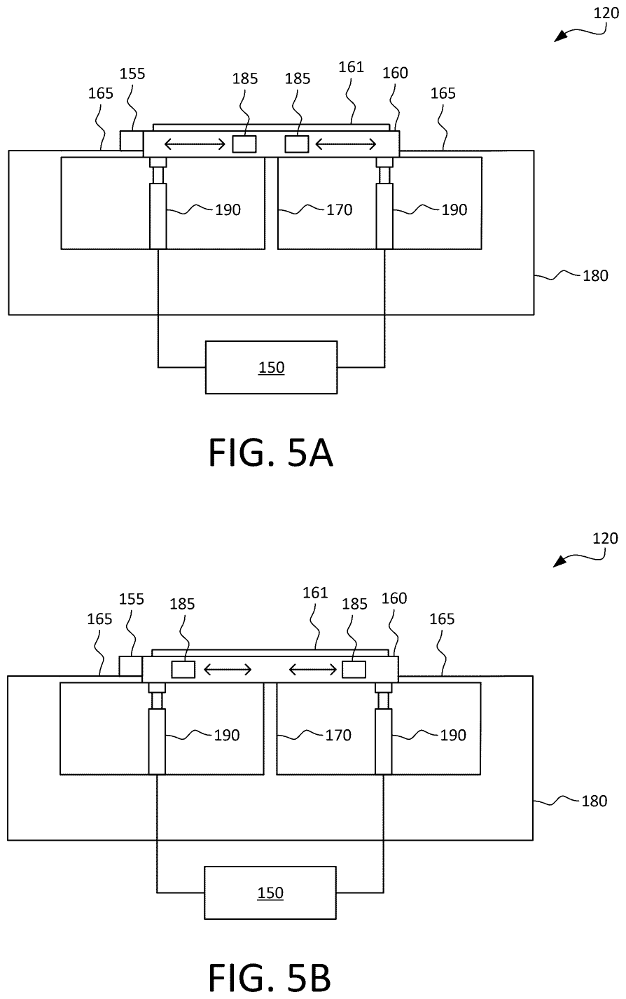

In some embodiments, the mirror assembly 120 may further comprise a pair of masses 185 disposed on the support member 160, as shown in FIG. 5A and FIG. 5B. In some embodiments, the pair of masses 185 may be magnetically disposed on the support member 160. The pair of masses 185 may be configured to move laterally along the support member 160 to adjust the angular inertia of the support member 160 and the angular range of oscillation of the support member 160. For example, by moving the pair of masses 185 inward relative to the center of the support member 160 (as shown in FIG. 5A), the angular inertia of the support member 160 may be reduced and the angular range of oscillation of the support member 160 may increase, while moving the pair of masses 185 outward relative to the center of the support member 160 (as shown in FIG. 5B), the angular inertia of the support member 160 may be increased and the angular range of oscillation of the support member 160 may decrease. It should be understood that the positions of the pair of masses 185 shown in FIG. 5A and FIG. 5B are exemplary, and the pair of masses 185 can be moved to other positions between and/or beyond the illustrated examples. The processor 150 may be configured to send instructions to an actuator to move the pair of masses 185 to adjust the angular inertia of the support member 160 and thereby adjust the angular range of oscillation of the support member 160. Consequently, the natural frequency of the mirror assembly 120 can be adjusted by adjusting the position of the pair of stiffness supports 175, which can allow for synchronization of the angular velocity with different linear velocities of the stage 105.

In some embodiments, the system 100 may further comprise a memory 151. The memory 151 may be configured to store a lookup table including pairs of linear velocities of the stage 105 and angular velocities of the support member 160. The processor 150 may be in electronic communication with the memory 151. For example, the processor 150 may be configured to obtain a target angular velocity of the support member 160 from the lookup table of the memory 151 based on the linear velocity of the stage 105 and adjust the mirror assembly 120 (e.g., moving the pair of stiffness supports 175 or the pair of masses 185) such that the support member 160 oscillates at the target angular velocity.

In some embodiments, the system 100 may further comprise a feedback sensor 155. The feedback sensor 155 configured to measure an oscillation frequency of the support member 160 relative to the base member 180. The feedback sensor 155 may comprise, for example, an encoder, a Hall-effect sensor, a strain gauge sensor, or an optical photodiode. The feedback sensor 155 may be disposed on the support member 160 (as shown in FIG. 2) or in a different arrangement, based on the type of sensor and the manner of measuring the oscillation frequency of the support member 160. The processor 150 may be in electronic communication with the feedback sensor 155. For example, the processor 150 may be configured to receive the oscillation frequency of the support member 160 measured by the feedback sensor 155 and may determine whether the oscillation frequency corresponds to the target angular velocity. In response to determining that the oscillation frequency correspond to the target angular velocity, the processor 150 may be configured to send instructions to the camera 130 to capture one or more images of the workpiece 101.

In some embodiments, in response to determining that the oscillation frequency does not correspond to the target angular velocity, the processor 150 may be configured to determine a correction value of the mirror assembly 120, such that the angular range of oscillation of the support member 160 corresponds to the target angular velocity. The correction value may comprise and adjustment in the position of the stiffness supports 175 or the position of the pair of masses 185.

The processor 150 may be further configured to send instructions to adjust the mirror assembly 120 based on the correction value, such that the support member 160 is configured to oscillate at an angular velocity that is synchronized with the linear velocity of the stage 105. For example, the processor 150 may be configured to send instructions to the one or more actuators that control the movement of the pair of stiffness supports 175 or the pair of masses 185 to adjust the positions of the pair of stiffness supports 175 or the pair of masses 185 based on the correction value. The processor 150 may continuously receive feedback from the feedback sensor 155 to verify that the oscillation frequency corresponds to the target angular velocity, and to make adjustments to the mirror assembly 120, to ensure optimal image resolution of the images of the workpiece 101 captured by the camera 130.

In some embodiments, in response to determining that the oscillation frequency does not correspond to the target angular velocity, the processor 150 may be configured to determine adjusted excitation signals for the voice coil 190, such that the angular range of oscillation of the support member 160 corresponds to the target angular velocity. For example, small adjustments to the excitation signals may affect the harmonic push/pull forces of the voice coil 190, which can ensure that the support member 160 oscillates at its natural frequency. The processor 150 may be further configured to apply the adjusted excitation signals to the voice coil 190, such that the voice coil 190 oscillates the support member 160 at the angular velocity synchronized with the linear velocity of the stage 105. The processor 150 may continuously receive feedback from the feedback sensor 155 to verify that the oscillation frequency corresponds to the target angular velocity, and to make adjustments to the excitation signals applied to the voice coil 190, to ensure optimal light budget and/or image resolution of the images of the workpiece 101 captured by the camera 130.

With the system 100, the mirror assembly 120 is configured to oscillate the mirror 161 at its natural frequency, such that its angular velocity is synchronized with the linear velocity of the stage 105. Accordingly, the light 112 reflected by the workpiece 101 can be directed to the camera 130 by the oscillating mirror 161, and the light budget and/or resolution of images captured by the camera 130 can be improved without blurring for better detection. Furthermore, the mirror assembly 120 can adapt to different scanning speeds of the stage 105 by adjusting positions of the pair of stiffness supports 175 of the pair of masses 185, which adjusts the angular range or angular inertia of the support member 160 and changes its natural oscillation frequency, regardless of the size of the mirror 161 and at high frequencies (e.g., greater than 1 KHz). Therefore, the system 100 can be used for optical inspection with fast verification and detection of defects in the workpiece 101.

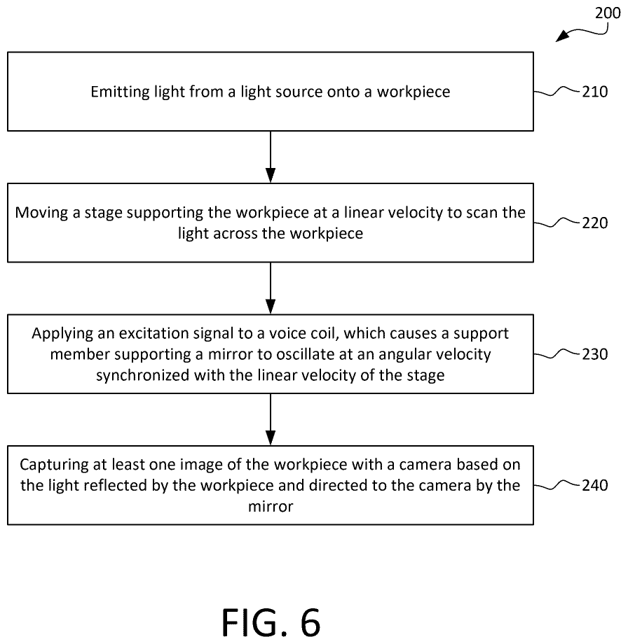

Another embodiment of the present disclosure provides a method 200. As shown in FIG. 6, the method 200 may comprise the following steps.

At step 210, light is emitted from a light source onto a workpiece. The light source may be configured to emit light in continuous or pulsed modes. The light may illuminate the workpiece for several microseconds or up to hundreds of microseconds or more.

At step 220, a stage supporting the workpiece is moved to scan the light across the workpiece. The stage may move with a linear velocity of 100 mm/s to 1000 mm/s.

At step 230, excitation signals are applied to a voice coil disposed on a base member of a mirror assembly on one side of a fulcrum. The fulcrum may centrally support a support member supporting a mirror, and the excitation signal can cause the voice coil to oscillate the support member relative to the fulcrum at an angular velocity synchronized with the linear velocity of the stage. The support member may be configured to oscillate at an angular velocity synchronized with the linear velocity of the stage.

At step 240, a camera captures at least one image of the workpiece based on the light reflected by the workpiece. The mirror is configured to direct the light reflected by the workpiece toward the camera as it oscillates with the support member at an angular velocity that is synchronized with the linear velocity of the stage, which allows the camera can “see” a frozen image and can receive a large quantity of reflected light, which can improve resolution of captured images.

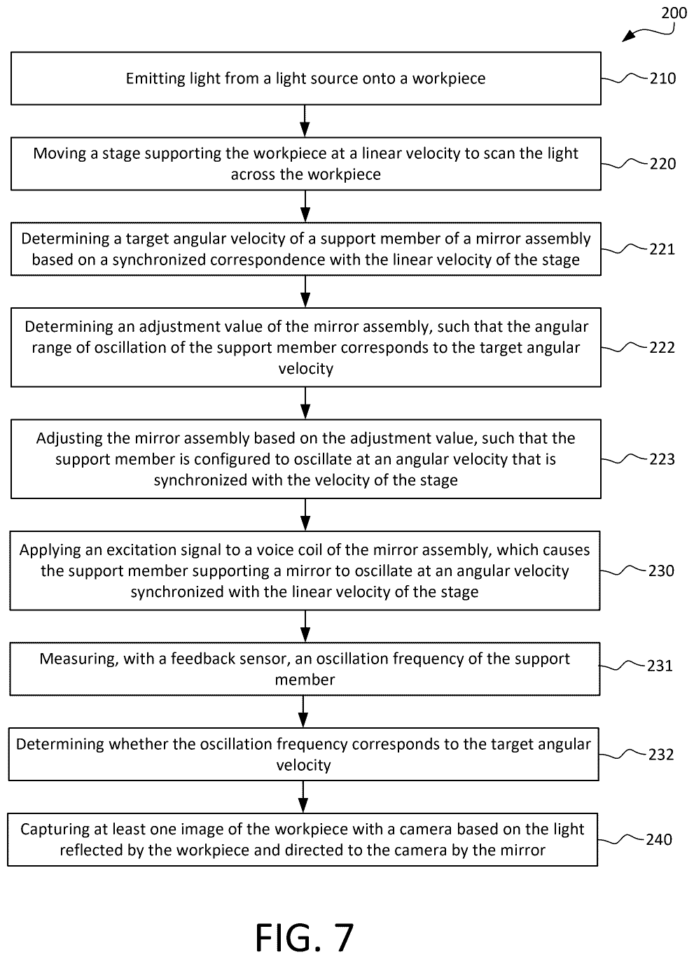

In some embodiments, the method 200 may further comprise the following steps before step 230, as shown in FIG. 7.

At step 221, a target angular velocity of the support member of the mirror assembly is determined based on a synchronized correspondence with the linear velocity of the stage. For example, when the support member oscillates at its natural frequency, a portion of the angular velocity is near-linear, which can be matched with the linear velocity of the stage. In some embodiments, a lookup table including pairs of linear velocities of the stage and angular velocities of the support member can be stored in a memory, and a processor can be configured to obtain the target angular velocity from the lookup table.

At step 222, an adjustment value of the mirror assembly is determined, such that the angular range of oscillation of the support member corresponds to the target angular velocity. For example, the mirror assembly may include a pair of stiffness supports or a pair of masses which are movable relative to the support member, which are configured to modify the angular range of oscillation and/or the angular inertia of the support member, and thereby changes the natural frequency of the support member.

At step 223, the mirror assembly is adjusted based on the adjustment value, such that the support member is configured to oscillate at an angular velocity that is synchronized with the velocity of the stage. For example, the positions of the pair of stiffness supports or the pair of masses may be adjusted according to the adjustment value, which adjusts the oscillation of the support member to reach the target angular velocity.

In some embodiments, the method 200 may further comprise the following steps before step 240, as further shown in FIG. 7.

At step 231, a feedback sensor measures an oscillation frequency of the support member. The feedback sensor may be an encoder, a Hall-effect sensor, a strain gauge sensor, or an optical photodiode or other type of sensor configured to measure the oscillation frequency of the support member.

At step 232, it is determined whether the oscillation frequency corresponds to the target angular velocity. For example, the processor may be configured to receive the oscillation frequency from the feedback sensor, and can compare the oscillation frequency to the target angular velocity.

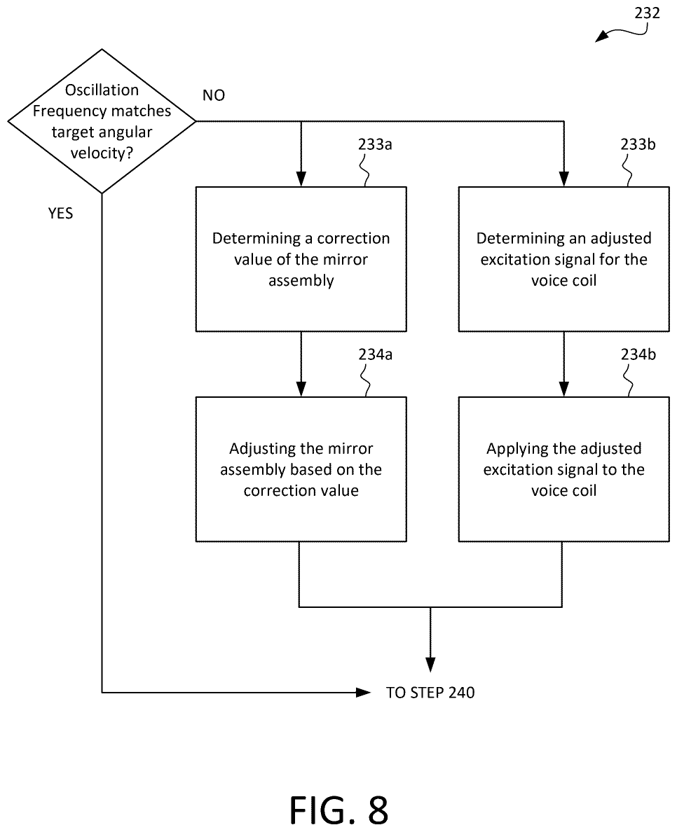

In some embodiments, step 232 may comprise the following decision steps shown in FIG. 8.

In response to determining that the oscillation frequency does not match the target angular velocity, a correction value of the mirror assembly can be determined in step 233a. The correction value may comprise an adjustment in the position of the pair of stiffness supports or the pair of masses.

At step 234a, the mirror assembly is adjusted based on the correction value, such that the support member is configured to oscillate at an angular velocity that matches the target angular velocity. For example, the one or more actuators which control the position of the pair of stiffness supports or the pair of masses can be controlled to change their respective positions according to the correction value.

Alternatively or in addition to step 233a, in response to determining that the oscillation frequency does not match the target angular velocity, adjusted excitation signal for the voice coil can be determined at step 233b.

At step 234b, the adjusted excitation signals is applied to the voice coil, such that the support member is configured to oscillate at an angular velocity that matches the target angular velocity.

In some embodiments, the steps of step 232 may be repeated based on continuous feedback from the feedback sensor to verify that the oscillation frequency corresponds to the target angular velocity, and make continuous adjustments before proceeding to step 240.

With the method 200, the voice coil oscillates the support member at its natural frequency, such that its angular velocity is synchronized with the linear velocity of the stage 105. Accordingly, the light reflected by the workpiece can be directed to the camera by the oscillating mirror, and the light budget and/or resolution of images captured by the camera can be improved without blurring for better detection. Furthermore, the mirror assembly can adapt to different scanning speeds of the stage by adjusting positions of the pair of stiffness supports of the pair of masses, which adjusts the angular range or angular inertia of the support member and changes its natural oscillation frequency, regardless of the size of the mirror and at high frequencies (e.g., greater than 1 KHz). Therefore, the method 200 can be used for optical inspection with fast verification and detection of defects in the workpiece.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a support member configured to support a mirror;
a fulcrum configured to centrally support the support member;
a base member configured to support the fulcrum;
a voice coil disposed on the base member on one side of the fulcrum and connected to one end of the support member; and
a processor configured to send an excitation signal to the voice coil, which causes the support member to oscillate relative to the fulcrum.

2. The system of claim 1, further comprising:
a pair of flexible extension members spanning from each end of the support member to the base member, wherein an effective length of the pair of flexible extension members limits an angular range of oscillation of the support member.

3. The system of claim 2, further comprising:
a pair of stiffness supports disposed on the base member beneath the pair of flexible extension members and configured to move laterally relative to the pair of flexible extension members to adjust the effective length of the pair of extension members and the angular range of oscillation of the support member.

4. The system of claim 3, wherein the processor is configured to send instructions to an actuator to move each of the pair of stiffness supports to adjust the effective length of the pair of extension members and the angular range of oscillation of the support member.

5. The system of claim 1, further comprising:
a pair of masses disposed on the support member and configured to move laterally along the support member to adjust an angular inertia of the support member and an angular range of oscillation of the support member.

6. The system of claim 5, wherein the processor is configured to send instructions to an actuator to move the pair of masses to adjust the angular inertia of the support member and the angular range of oscillation of the support member.

7. The system of claim 1, further comprising:
a feedback sensor disposed on the support member and configured to measure an oscillation frequency of the support member.

8. The system of claim 1, further comprising:
a light source configured to emit light onto a workpiece; and
a camera configured to capture an image of the workpiece based on the light reflected by the workpiece, wherein the mirror is configured to direct the light reflected by the workpiece toward the camera.

9. The system of claim 8, further comprising:
a stage configured to support the workpiece, wherein the stage is movable to scan the light emitted by the light source across the workpiece;
wherein the camera is configured to capture a plurality of images of the workpiece as the stage scans the light emitted by the light source across the workpiece.

10. The system of claim 9, wherein the stage is movable at a linear velocity, and the support member is configured to oscillate at an angular velocity synchronized with the linear velocity.

11. The system of claim 10, further comprising:
a pair of flexible extension members spanning from each end of the support member to the base member, wherein an effective length of the pair of flexible extension members limits an angular range of oscillation of the support member; and
a memory configured to store a lookup table including pairs of linear velocities of the stage and angular velocities of the support member, wherein the processor is configured to obtain a target angular velocity of the support member based on the linear velocity of the stage and adjust the effective length of the pair of extension members such that the support member oscillates at the target angular velocity.

12. A method comprising:
emitting light from a light source onto a workpiece;
moving a stage supporting the workpiece to scan the light emitted by the light source across the workpiece, wherein the stage is moved at a linear velocity;
applying an excitation signal to a voice coil disposed on a base member of a mirror assembly on one side of a fulcrum, wherein the fulcrum centrally supports a support member supporting a mirror, and the excitation signal causes the voice coil to oscillate the support member relative to the fulcrum at an angular velocity synchronized with the linear velocity of the stage; and
capturing at least one image of the workpiece with a camera based on the light reflected by the workpiece, wherein the mirror is configured to direct the light reflected by the workpiece toward the camera.

13. The method of claim 12, wherein the method further comprises:
determining a target angular velocity of the support member based on a synchronized correspondence with the linear velocity of the stage;
determining an adjustment value of the mirror assembly, such that an angular range of oscillation of the support member corresponds to the target angular velocity; and
adjusting the mirror assembly based on the adjustment value, such that the support member is configured to oscillate at an angular velocity that is synchronized with the linear velocity of the stage.

14. The method of claim 13, further comprising:
measuring, with a feedback sensor, an oscillation frequency of the support member; and
determining whether the oscillation frequency corresponds to the target angular velocity.

15. The method of claim 14, further comprising:
in response to determining that the oscillation frequency does not correspond to the target angular velocity, determining a correction value of the mirror assembly, such that the angular range of oscillation of the support member corresponds to the target angular velocity; and
adjusting the mirror assembly based on the correction value, such that the support member is configured to oscillate at an angular velocity that is synchronized with the linear velocity of the stage.

16. The method of claim 15, wherein a pair of flexible extension members span from each end of the support member to the base member, and a pair of stiffness supports are disposed on the base member beneath the pair of flexible extension members, and adjusting the mirror assembly based on the adjustment value comprises:
moving the pair of stiffness supports according to the adjustment value.

17. The method of claim 16, wherein adjusting the mirror assembly based on the correction value comprises:
moving the pair of stiffness supports according to the correction value.

18. The method of claim 15, wherein a pair of masses are disposed on the support member, and adjusting the mirror assembly based on the adjustment value comprises:
moving the pair of masses according to the adjustment value.

19. The method of claim 18, wherein adjusting the mirror assembly based on the correction value comprises:
moving the pair of masses according to the correction value.

20. The method of claim 14, further comprising:
in response to determining that the oscillation frequency does not correspond to the target angular velocity, determining an adjusted excitation signal for the voice coil; and
applying the adjusted excitation signal to the voice coil, such that the voice coil oscillates the support member at the angular velocity synchronized with the linear velocity of the stage.
